(19) United States
(12) Patent Application Publication
(10) Pub. No.: US 2007/0154599 A1
(43) Pub. Date: Jul. 5, 2007

(54) Method of Producing Edible Packaging Container

(75) Inventor: Chih-Ming Kao, Taipei (TW)

Correspondence Address: SHOEMAKER AND MATTARE, LTD, 10 POST OFFICE ROAD - SUITE 110, SILVER SPRING, MD, 20910, US

(73) Assignee: I-MEI FOODS CO., LTD., Taipei (TW)

(21) Appl. No.: 11/616,959

(22) Filed: Dec. 28, 2006

(30) Foreign Application Priority Data
Dec. 30, 2005 (TW) 094147465

(51) Int. Cl. A21D 13/00

(52) U.S. Cl. 426/94

(57) ABSTRACT

A method of producing an edible packaging container is proposed, comprising the steps of: (a) preparing a kneaded batter; (b) forming an oil-layer region on the center portion of one side of the batter and a water-moisturizing region on the periphery of the same side of the batter; (c) folding up the batter by turning the oil-layer region thereof inwardly, and combining the a portion of the batter by machinery to form edges comprising the water-moisturizing region; and (d) cooking the batter by steaming and cutting along the folded lines to form a pocket-shaped container, thereby achieving the goal of mass production of an edible pocket container.

### FIELD OF THE INVENTION

The present invention relates to methods of making edible food containers, and more particularly, to a method for making an edible packaging container comprising fermentable wheat flour.

### BACKGROUND OF THE INVENTION

Following a healthy diet is one of the most important things modern people can do to help maintain their overall health. Along with physical activity, the diet is the key factor that affects weight. Being overweight or obese increases risks of heart disease and many other diseases. Fortunately, nowadays, people are becoming more conscious of the importance of keeping fit and living healthy. In order to maintain a healthy diet, it is necessary to choose modes of cooking that are good for the health. Modes like barbecuing and frying at high temperature adversely affect valuable nutrients and often utilize too much oil. It has been well established that such processing may easily lead to weight gain, artery-vein and heart diseases, and damage to the metabolic system. Consequently, healthier modes of cooking such as water steaming are being favored. In particular, food made of fermentable flour cooked by water steaming has become a mainstream, as it is easy to digest and filling.

Food made of fermentable flour is often divided into two kinds: one made without fillings and one made with fillings stuffed therein. However, food, such as bread, made without fillings is often perceived to lack variety in flavor. And food made with fillings and then cooked by steam does not permit consumers to change the fillings as desired. Therefore, fermentable flour type foods having fillings that can be conveniently changed and that can be eaten directly without cooking, such as the so-called Chinese-Hamburger, have become increasingly popular among consumers.

FIGS. 1A to 1C illustrate a common method of producing a conventional Chinese-Hamburger. As depicted in FIG. 1A, an oval-shaped batter 100 is first formed for making a batter cover. Then, as shown in FIG. 1B, the surface of the oval-shaped batter 100 is coated with an edible oil to form an oil layer region 110 thereon. Lastly, as shown in FIG. 1C, the oval-shaped batter 100 is folded by turning the oil layer region 110 inwardly, resulting in-after cooking-a batter cover 110′ formed with an interior space or opening 150 for fillings that is open on three sides and closed at the fold. However, such a batter cover having an opening with only one closed side can easily expose and drop the fillings that are stuffed therein, as shown in FIG. 2, making it inconvenient to carry or eat. Therefore, it is desirable to develop an edible food container that is convenient to stuff fillings therein and is easy to eat and carry.

### SUMMARY OF THE INVENTION

A primary objective of the present invention is to provide a method of producing an edible packaging container that retains stuffed fillings while eating or carrying.

Another primary objective of the present invention is to provide a method of producing an edible packaging container that is applicable to mass production.

To achieve the above and other objectives, the present invention proposes a method of producing an edible packaging container, comprising the steps of: (a) preparing a kneaded batter; (b) forming an oil-layer region on the center portion of one side of the batter and a water-moisturizing region on the periphery of one side of the batter; (c) folding the batter by turning the oil-layer region thereof inwardly, and combining a portion of the batter by machinery to form the edge comprising the water-moisturizing region; and (d) cooking the batter by steaming and cutting along the folded lines to form a pocket-shaped container. The edible pocket container is produced by forming an oil-layer region and a water-moisturizing region at predetermined positions of the batter surface, enabling the edible pocket container to be made by machinery in mass production rather than by hand using the fingers to roll up the batter, thereby achieving the goal of mass production of the edible pocket container.

The present invention further discloses a method of producing an edible container, comprising the steps of: (a) preparing two pieces of identically-shaped batters; (b) forming an oil-layer region in the center portion and one edge of one side of each of the batters, and forming a water-moisturizing region on each of the remaining edges of one side of each of the batters; (c) folding up the two batters such that the oil-layer regions thereof are facing, and kneading a portion of the batters by machinery to form the edges comprising the water-moisturizing regions; and (d) cooking the folded batters by steaming to form an edible pocket-shaped container.

### BRIEF DESCRIPTION OF THE DRAWINGS

The method of producing an edible packaging container of the present invention can be fully understood by reading the following detailed description of the preferred embodiments, with reference made to the accompanying drawings, wherein:

FIGS. 1A to 1C (PRIOR ART) are perspective views showing the steps of producing a conventional batter cover for a Chinese-Hamburger;

FIG. 2 (PRIOR ART) is a perspective view showing a conventional batter cover for a Chinese-Hamburger stuffed with fillings;

FIGS. 3A to 3D are perspective views showing the steps of making a first preferred embodiment of the present invention;

FIGS. 4A and 4B are perspective views showing the method of producing an edible packaging container in accordance with the present invention;

FIGS. 5A to 5D are perspective views showing the steps of making a second preferred embodiment of the present invention.

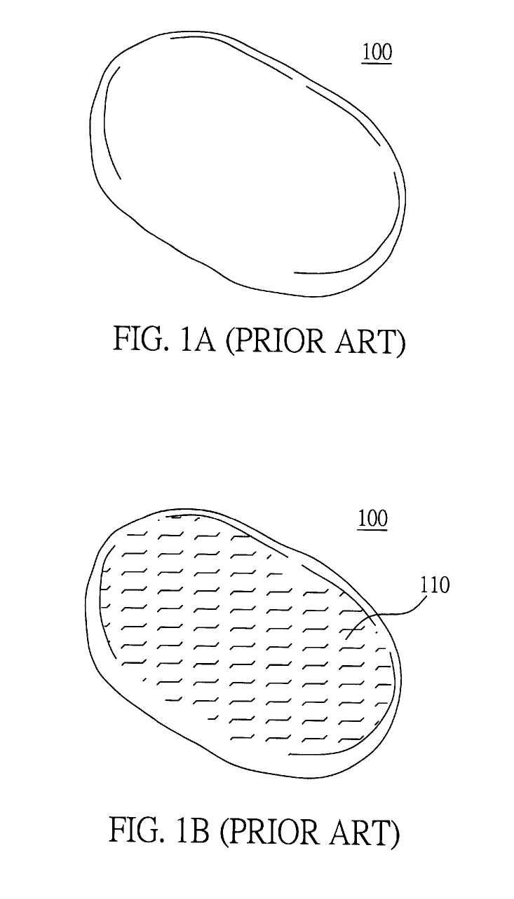

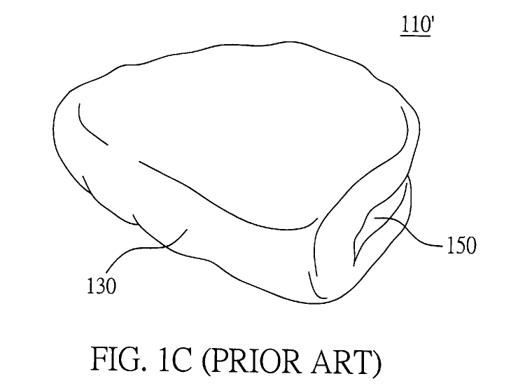

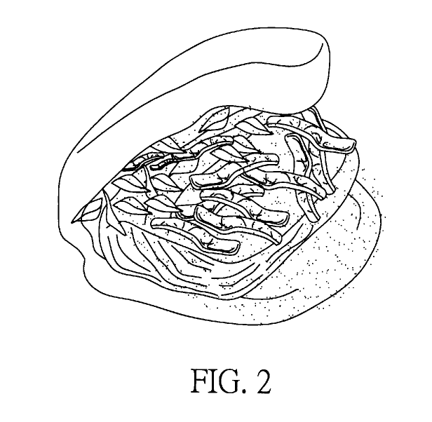

### DESCRIPTION OF THE PREFERRED EMBODIMENT

The present invention is described in the following so that one skilled in the pertinent art can easily understand other advantages and effects of the present invention. The present invention may also be implemented and applied according to other embodiments, and the details may be modified based on different views and applications without departing from the spirit of the invention.

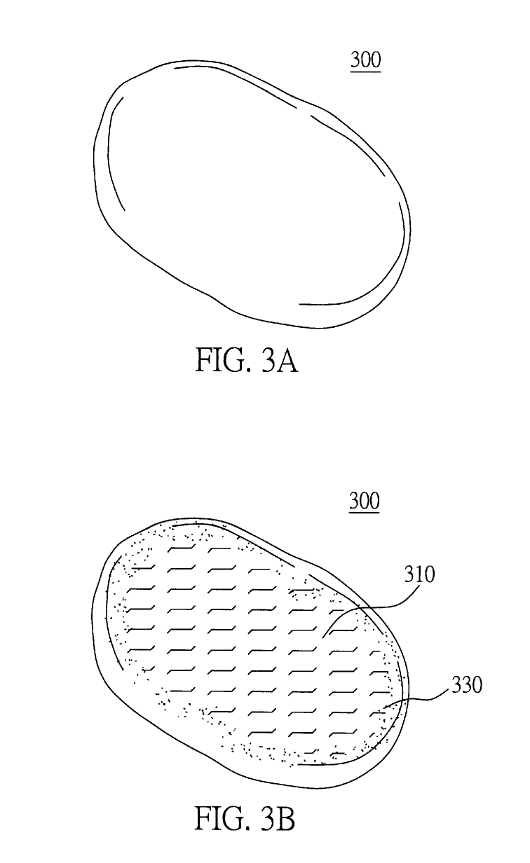

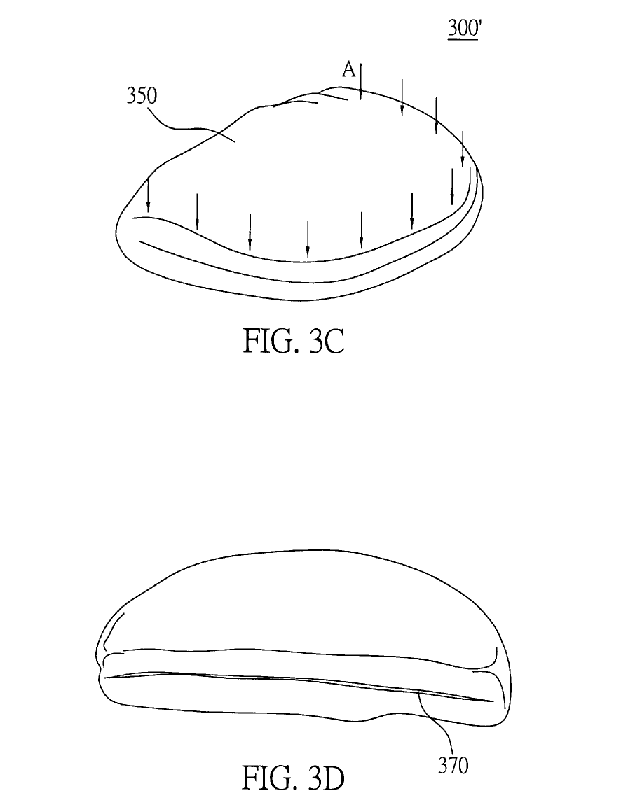

FIGS. 3A to 3D depict a first preferred embodiment of the present invention; which is made by first kneading a combination of mixed ingredients that includes wheat flour, sugar, oil, powder, yeast, water and likely others to form a smooth and even batter having an appropriate elasticity. Next, the kneaded batter is put aside and left for about ten to twenty minutes to become loose. Then, the batter is cut into a plurality of small batters and each of the plurality of small batters is rolled into an oval-shaped batter 300 as depicted in FIG. 3A. Thereafter, an edible type of oil is applied to the surface of the center portion of the oval-shaped batter to form an oil-layer region 310. Filtered water is then sprayed by a spray nozzle on the surface of the periphery of the oval-shaped batter surface 300 to form an even water-moisturizing region 330 as shown by FIG. 3B. Subsequently, the oval-shaped batter is folded by turning the oil layer region inwardly to form a folded batter layer 300′ having a hemispherical shape. Then, referring to FIG. 3C, the folded batter layer 300′ is kneaded by machinery along the edge shown by the vertical arrows A, avoiding the center portion having an oil layer region 310, to form an edge having a water-moisturizing region 330, thereby forming a semi-finished flour-yeasted packaging container. Then, the semi-finished flour-yeasted packaging container is placed into a yeast tank to undergo a yeast fermentation process for twenty to forty minutes, followed by placement in a steaming cage to steam for about fifteen minutes at a temperature of about 90 degrees. Lastly, as shown by FIG. 3D, the packaging container is cut along the folding line 350 to form an opening 370.

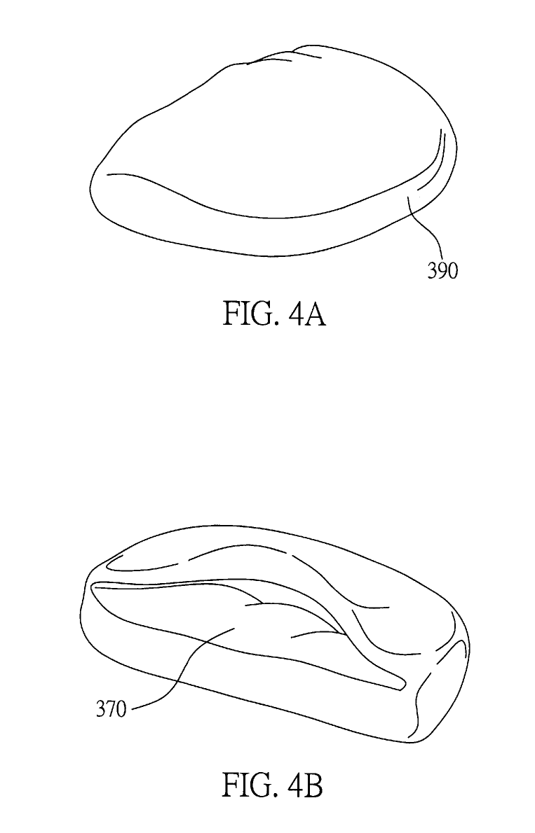

In that the center portion of the folded batter layer 300′ is formed with an oil layer region and is not pressed during kneading after the batter is folded, the center portion of the folded batter layer 300′ having an oil layer region is not combined and thus has a hollow gap between the upper layer and the lower layer thereof after cooking the semi-finished packaging container by steam. On the other hand, the edge of the folded batter layer between the upper layer and the lower layer thereof is formed with a water-moisturizing area by spraying filtered water thereon and is combined by kneading by machinery, therefore, after cooking the semi-finished packaging container by steam, the edge of the folded batter layer having a water-moisturizing region is combined to form a sealed side 390 as shown in FIG. 4A.

Thereafter, after cutting along the folded side, a pocket-shaped container is formed that has only one side thereof formed with an opening 370, while the remaining edges are sealed to form a hollow portion for packaging fillings therein as shown by FIG. 4B. In this embodiment, the pocket-shaped container is used as a cover for making a Chinese-Hamburger, wherein the fillings to be filled into the central hollow portion of the Chinese-Hamburger such as meat slices, pickled cabbage, peanut powder and the like-can be inserted into the pocket container through the opening 370. Compared to the known batter cover used for making a Chinese-Hamburger that typically has one closed side with the remaining sides open, the edible pocket container disclosed by the invention is provided with a hollow pocket to contain the fillings therein, making it more convenient to eat or carry. Moreover, the pocket container is characterized in that an oil-layer region and a water-moisturizing region are respectively formed at predetermined positions of the batter surface, thereby overcoming the drawback of the prior art that the edible container is not readily applicable to mechanized mass production.

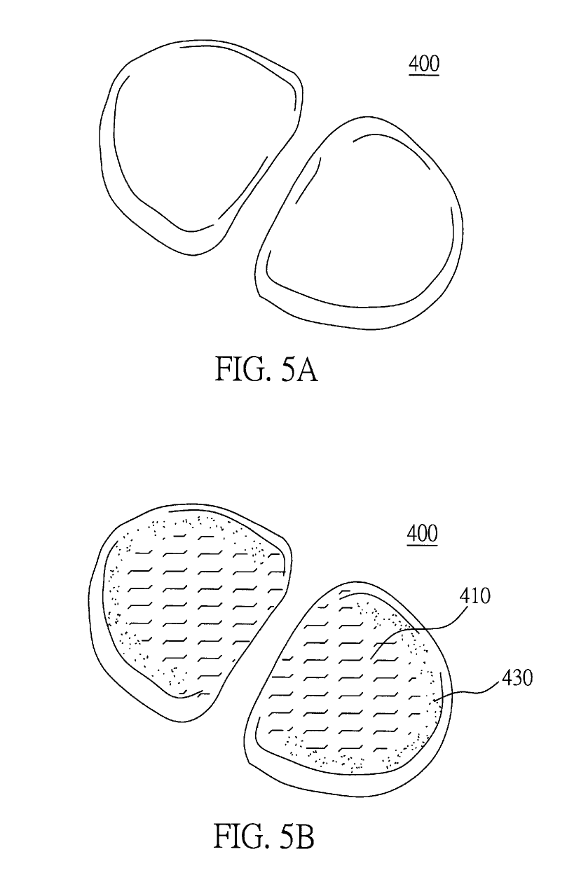

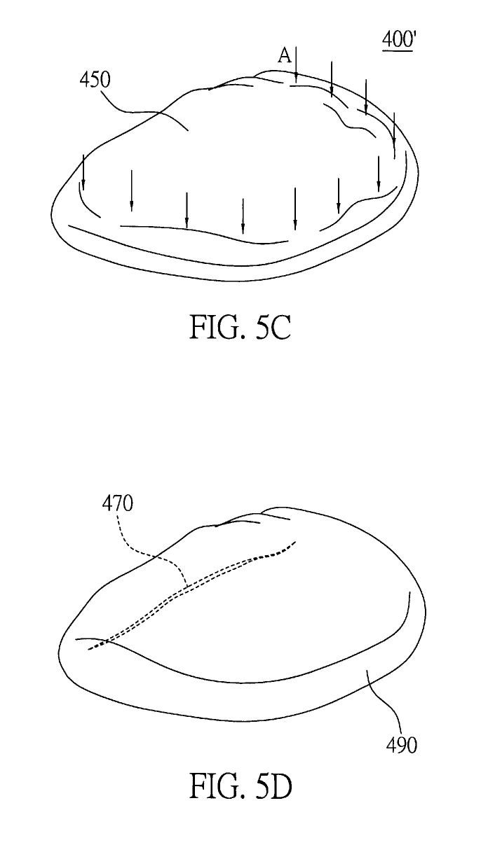

FIGS. 5A to 5D depict a second preferred embodiment of the present invention; which is made by first kneading a combination of mixed ingredients that includes wheat flour, sugar, oil, powder, yeast, water and likely others to form a smooth and even batter having an appropriate elasticity. Next, the batter is put aside and left for about ten to twenty minutes to become loose. Then, the batter is cut into a plurality of small batters and each of the plurality of small batters is rolled into a hemisphere-shaped batter 400, as depicted in FIG. 5A. Thereafter, referring to FIGS. 5B and 5C, an edible type of oil is applied to the surface of the center portion and the non-arc-shaped (linear) side 450 of the hemisphere-shaped batters to form an oil-layer region 410, and filtered water is sprayed by a spray nozzle on the surface 400 of the arc-shaped edges of the hemisphere-shaped batters to form an even water-moisturizing region 430. Subsequently, two identical hemisphere-shaped batters are placed together by facing the oil layer regions thereof to form a superposed batter layer 400′ retaining the hemispherical shape, as shown in FIG. 5C. Then, the superposed batter layer 400′ is kneaded by machinery along the arc-shaped edge as indicated by the vertical arrows A, avoiding pressing the center portion having an oil layer region 410, to form an edge having a water-moisturizing region 430, thereby forming a semi-finished yeasted flour packaging container. Then, the semi-finished yeasted flour packaging container is placed into a yeast tank to undergo a yeast process for twenty to forty minutes, followed by placement of the yeasted flour container in a steaming cage to steam at a temperature of about 90 degrees for about fifteen minutes

Reviewing, an oil layer region is respectively formed on the inner center portion and the edges of the non-arc-shaped (linear) side of the superposed batter layer 400′ and a water-moisturizing region is formed on the arc-shaped edges thereof. The center portion thereof having an oil-layer is not pressed to combine after the superposed batters are folded by machinery. Consequently, after cooking the semi-finished packaging container by steam, the center portion having an oil layer region and the non-arc-shaped side of the superposed batter layer 400′ are not combined and thus a hollow gap exists between the upper layer and the lower layer thereof. On the other hand, the arc-shaped edge of the superposed batter layer having a water-moisturizing area between the upper layer and the lower layer thereof is kneaded to combine by machinery to form a sealed side 490 as indicated by FIG. 5D. Note that only the periphery of the arc-shaped edge is formed with a water-moisturizing region in this embodiment. Also, in addition to the center portion that has an oil-layer region, the non-arc-shaped (linear) edges of the hemisphere-shaped superposed batter layers are also formed with an oil-layer region. Therefore, after kneading by machinery to combine the hemisphere-shaped superposed batter layers, a yeast fermentation process, and cooking by steam, an edible hemisphere-shaped container is formed with a center hollow pocket that has only one edge formed with an opening 470 without requiring a cutting process while the remaining edges are sealed.

Besides the hemisphere-shaped pocket container, the method of producing an edible container disclosed by the invention can also produce other pocket containers in a variety of shapes depending on the preferences and applications, such as folding one or superposing two rectangular batter covers to form a square-shaped pocket container, and folding one diamond shaped or superposing two triangular batter covers to form an edible triangular pocket container, and so on.

Having thus described preferred embodiments of the invention in sufficient detail to enable those skilled in the art to make and use the invention, it will nevertheless be appreciated that numerous variations and modifications of the illustrated embodiment may be made without departing from the spirit of the invention, and it is intended that the invention not be limited by the above description or accompanying drawings, but that it be defined solely in accordance with the appended claims.

What is claimed is:

1. A method of producing an edible packaging container, comprising the steps of:
(a) preparing a kneaded batter;
(b) forming an oil-layer region on the center portion of one side of the batter and a water-moisturizing region on the periphery of one side of the batter surface;
(c) folding the batter along a line by turning the oil-layer region thereof inwardly, and combining a portion of the batter by machinery to form the edges comprising the water-moisturizing region; and
(d) cooking the batter by steaming and cutting along the folding line to form a pocket-shaped container.

2. The production method according to claim 1, wherein the oil layer region is formed by coating an edible type of oil on a surface of the batter(s).

3. The production method according to claim 1, wherein the water-moisturizing region is formed by spraying filtered water thereon.

4. An edible pocket container produced by the method according to claim 1, wherein the edible container is used to make a Chinese-Hamburger.

5. A method of producing an edible packaging container, comprising the steps of:
(a) preparing two pieces of identically-shaped batters;
(b) forming an oil-layer region in the center portion and one edge of one side of each of the batters and forming a water-moisturizing region on the remaining edges of one side of each of the batters;
(c) folding up the two batters by facing the oil-layer regions thereof, and kneading the batters by machinery to form the edges having a water-moisturizing region; and
(d) cooking the folded batters by steam to form an edible pocket-shaped container.

6. The production method according to claim 5, wherein the batter has a hemispheric outline.

7. The production method according to claim 6, wherein the arc-shaped edges of the hemisphere-shaped batter surface are formed with a water-moisturizing region.

8. The production method according to claim 6, wherein the center portion and the non-arc-shaped edge of the hemisphere-shaped batter surface is formed with an oil layer region.

9. The production method according to claim 5, wherein the oil layer region is formed by coating an edible oil on a surface of the batter(s).

10. The production method according to claim 5, wherein the water-moisturizing region is formed by spraying filtered water thereon.

11. An edible pocket container produced by the method according to claim 5, wherein the edible container is used to make a Chinese-Hamburger.
